(19) United States
(12) Patent Application Publication
(10) Pub. No.: US 2026/0303761 A1
(43) Pub. Date: Oct. 1, 2026

(54) ULTRAHIGH BANDGAP ALGAN CHANNEL HEMTS WITH LOW CONTACT RESISTANCE

(71) Applicant: Wisconsin Alumni Research Foundation, Madison, WI (US)

(72) Inventors: Shubhra S. Pasayat, Middleton, WI (US); Swarnav Mukhopadhyay, Madison, WI (US); Chirag Gupta, Middleton, WI (US); Khush Gohel, Madison, WI (US)

(21) Appl. No.: 19/093,682

(22) Filed: Mar. 28, 2025

(51) Int. Cl. H04N 9/31; G02B 5/30

(52) U.S. Cl. CPC H04N 9/3105; G02B 5/305; H04N 9/3152; H04N 9/3158; H04N 9/3164; H04N 9/3167; H04N 9/3185

(57) ABSTRACT

Aluminum gallium nitride (AlGaN) channel high electron mobility transistors (HEMTs), methods of operating the AlGaN HEMTs, and methods of making the AlGaN HEMTs are provided. The AlGaN HEMTs include source and drain contacts on a highly n-type doped, reverse graded AlGaN contact layer. At least a portion of the HEMT heterostructure is partially or fully strained relaxed to provide low contact resistance at the interface between the contact layer and the source and/or drain contact.

### BACKGROUND

Group III-nitride-based ultra-wide bandgap (UWBG) transistors show promise for high voltage and high-frequency electronics due to their UWBG, high critical electric field, and high saturation velocity at elevated temperatures. UWBG AlGaN channel devices have shown high breakdown voltage, low on-resistance, and moderate RF performance.

UWBG AlGaN devices have applications in mid-frequency (e.g., 10-40 GHz) power amplifiers and high voltage (e.g., >2000 V) power converters. AlGaN channel HEMTs are suitable for operating at high voltage and, at some operational frequencies, they can deliver higher output power than GaN channel HEMTs. However, the high Al content required for the AlGaN channel in UWBG AlGaN channel HEMTs results in high contact resistance and non-ohmic source and drain contacts. The non-ohmic (Schottky) contacts impede the flow of electrons between the two-dimensional electron gas (2DEG) channel and the source and drain of the HEMT, thereby limiting device performance.

To address the non-ohmic contact problem, reverse graded, highly n-type doped (n⁺⁺) AlGaN contact layers have been used to reduce the Al content of the AlGaN at the source and drain contacts. Although reverse graded AlGaN contact layers have reduced the Schottky barrier height at the source and drain contacts, the contacts remain highly resistive. Moreover, the reverse graded AlGaN increases the compressive strain in the HEMT heterostructure, increases surface roughness, and degrades the 2DEG mobility.

### SUMMARY

Ultra-high bandgap AlGaN channel HEMTs are provided. The ultra-high bandgap HEMTs include a strained heterostructure on a substrate, the strained heterostructure comprising: a channel layer comprising Al_{y}Ga_{1-y}N where y>0.35; a two-dimensional electron gas confined in the channel layer; an AlN interlayer on the channel layer; a barrier layer on the AlN interlayer, the barrier layer comprising Al_{z}M_{1-z}N, wherein M represents Ga, Sc, Y, B, or In and z>0.5; and a contact layer on the barrier layer or etched and regrown into or through the barrier layer. The contact layer comprises reverse graded n-type doped AlₓGa₁₋ₓN, where 1≤x≤0, having an n-type dopant concentration in a range from 1×10¹⁸ cm⁻³ to 5×10²⁰ cm³. The heterostructure may optionally also include a buffer layer between the substrate and the channel layer. One or more layers in the heterostructure, including the contact layer, are fully or partially strain-relaxed. The HEMTs further include a source contact on the contact layer; a drain contact on the contact layer; and a gate contact on the barrier layer.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIGS. 1A-1B. An example of a conventional HEMT structure (FIG. 1A) and a Schottky contact formed between a AlGaN barrier layer and the source and drain (S/D) contacts due to a high contact resistance at the interface.

FIGS. 2A-2C. The formation of Schottky contacts at interfaces between the source and drain contact and the underlying AlGaN alloy in an AlGaN HEMT before (FIG. 2A) and after a thermal anneal (FIG. 2B). FIG. 2C illustrates strain relaxation creating a higher density of dislocation defects and nitrogen vacancies and, therefore, a high degree of metal diffusion into an underlying AlGaN layer.

FIG. 3. Schematic diagram showing the layers in an illustrative AlGaN HEMT.

FIG. 4. Schematic diagram of a HEMT in which the buffer layer, channel layer, AlN interlayer, and barrier layer retain the compressive strain imparted by growth on the lattice mismatched substrate, while etched and regrown n⁺⁺ reverse graded contact layers making edge contact with the 2DEG are fully or partially strain relaxed.

FIG. 5. Schematic diagram of a HEMT in which the buffer layer, channel layer, AlN interlayer, and barrier layer retain the compressive strain imparted by growth on the lattice mismatched substrate, while n⁺⁺ reverse graded contact layers regrown on the barrier layer are fully or partially strain relaxed.

FIG. 6. Schematic diagram of a HEMT in which the buffer layer, channel layer, AlN interlayer, and barrier layer retain the compressive strain imparted by growth on the lattice mismatched substrate, while partially etched and regrown n⁺⁺ reverse graded contact are fully or partially strain relaxed.

FIG. 7. Schematic diagram of a HEMT in which the buffer layer, channel layer, AlN interlayer, barrier layer, and a lower portion of the n⁺⁺ reverse graded contact layer retain the compressive strain imparted by growth on the lattice mismatched substrate, while the upper portions of the n⁺⁺ reverse graded contact layers are regrown and are fully or partially strain relaxed.

FIG. 8 shows a variation of a HEMT in which the heterostructure omits a buffer layer, such that the channel layer is grown directly on the substrate.

FIG. 9 shows a variation of a HEMT in which the heterostructure omits a buffer layer and includes a channel layer having a superlattice (SL) structure.

FIG. 10 shows a variation of a HEMT in which the heterostructure omits a buffer layer and includes a graded channel layer.

FIG. 11 shows a variation of a HEMT in which the heterostructure omits a buffer layer and includes a barrier layer having a superlattice (SL) structure.

FIG. 12 shows a multichannel HEMT heterostructure.

FIG. 13. Epitaxial structure of a fully-strained AlGaN channel HEMT in accordance with the Example.

FIG. 14. Epitaxial structure of a partially strain-relaxed AlGaN channel HEMT in accordance with the Example.

FIGS. 15A-15C. (FIG. 15A) TLM measurement of a fully strained HEMT (Sample A) and a partially relaxed HEMT (Sample B), RSM scan of (FIG. 15B) a fully strained HEMT (Sample A) and (FIG. 15C) a partially relaxed HEMT (Sample B) at (−1-14) AlN plane.

FIGS. 16A-16C. I_{D}−V_{D} characteristics of (FIG. 16A) a fully strained HEMT and (FIG. 16B) a partially relaxed HEMT; (FIG. 16C) I_{D}−V_{G} characteristics of fully strained and partially relaxed HEMTs.

FIG. 17. Breakdown characteristics of a fully strained HEMT and a partially relaxed HEMT demonstrating >2 kV of breakdown voltage.

FIG. 18. Specific contact resistivity with Al content in the contact layer. (A. G. Baca, Journal of Vacuum Science & Technology A 38(2), 020803 (2020); M. T. Alam, et al., Appl. Phys. Express, (2024); S. Bajaj et al., IEEE Electron Device Letters 39(2), 256-259 (2018); S. Mollah et al., Applied Physics Letters 117(23), 232105 (2020); A. Mamun et al., Appl. Phys. Express 16(6), 061001 (2023); B. Klein et al., Advanced Materials Interfaces, 2301080 (2024); H. Xue et al., Microelectronic Engineering 237, 111495 (2021); M. Hiroki et al., Applied Physics Letters 115(19), 192104 (2019); Y. Zhu et al., “Heterostructure and Interfacial Engineering for Low-Resistance Contacts to Ultra-Wide Bandgap AlGaN,” arXiv:2411.10566, (2024); B. Da et al., Appl. Phys. Express 17(10), 104002 (2024); M. Hiroki et al., IEEE Electron Device Letters 43(3), 350-353 (2022); D. Chettri et al., J. Phys. D: Appl. Phys. 58(3), 035104 (2024); I. Abid et al., Electronics 10(6), 635 (2021); X. Hu et al., IEEE Electron Device Letters 39(10), 1568-1571 (2018); E. A. Douglas et al., Physica Status Solidi (a) 214(8), 1600842 (2017).)

### DETAILED DESCRIPTION

UWBG AlGaN channel HEMTs, methods of operating the HEMTs, and methods of making the HEMTs are provided. The HEMTs include source and drain contacts on a highly n-type doped, reverse graded AlGaN contact layer. At least a portion of the HEMT heterostructure is partially or fully strained relaxed to provide low contact resistance at the interface between the contact layer and the source and/or drain contact, without sacrificing the crystal quality of the heterostructure or HEMT performance. The AlGaN channel HEMTs may be metal-polar, N-polar, semi-polar, or non-polar.

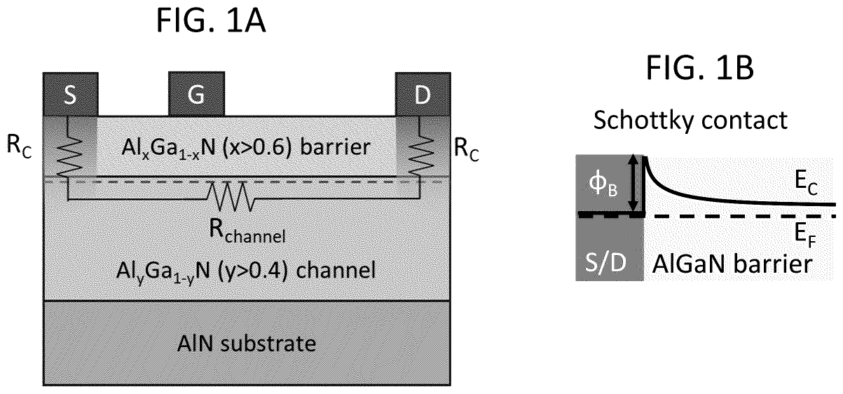

An example of a portion of a conventional HEMT structure is shown schematically in FIG. 1A. The HEMT includes an epitaxial heterostructure composed of an AlGaN barrier layer on an AlGaN channel layer. Because the AlGaN of the barrier layer has a wider bandgap, due to a higher Al content in the AlGaN alloy, than the AlGaN of the channel layer, the bandgap discontinuity and difference in polarization charge results in charge transfer from the barrier layer to the channel layer and accumulation of charge at the interface, resulting in the formation of a two-dimensional electron gas (2DEG) (dashed line) just below the interface. The 2DEG has a high electron density and a high electron mobility and acts as a channel for electron current to flow from a source contact (S) to a drain contact (D). A gate voltage applied to a gate contact (G) positioned above the 2DEG channel is used to modulate the flow of electrons in the 2DEG.

In a conventional UWBG AlGaN HEMT, a Schottky contact is formed between the AlGaN heterostructure and the source and drain (S/D) contacts due to the high contact resistance at the interface between the metal of the S/D contacts and the Al-rich AlGaN, as illustrated in FIG. 1B. The Schottky contacts resist the flow of electrons between the source contact and the drain contact and the 2DEG, degrading the performance of the HEMT.

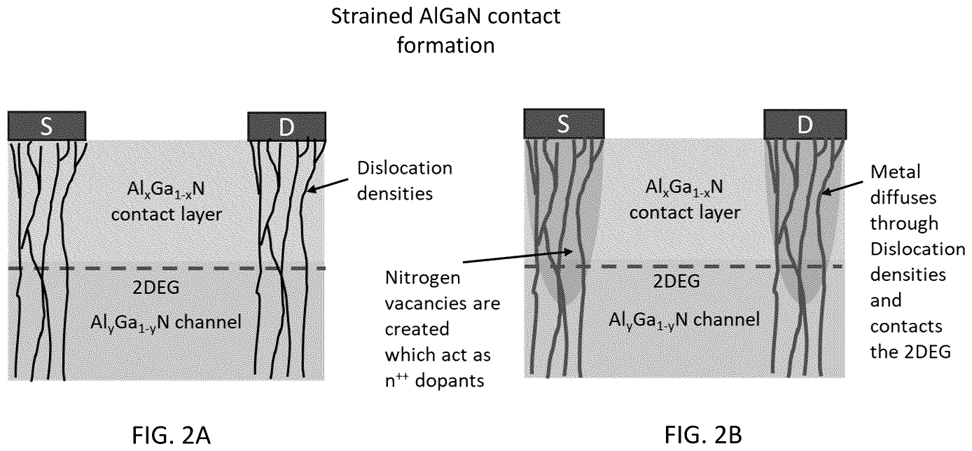

The formation of metal contacts on an UWBG AlGaN channel HEMT is shown schematically in FIGS. 2A and 2B. Once the metal source and drain contacts are deposited onto a HEMT heterostructure (FIG. 2A) a thermal anneal results in the diffusion of metal from the S/D contacts into the underlying AlGaN layers (FIG. 2B) and this diffusion is facilitated by dislocation defects and nitrogen vacancies, which act as n⁺⁺ dopants in the AlGaN layers. Ideally, the metal diffusion would be sufficient to produce an ohmic contact. However, in a strained UWBG AlGaN channel HEMT heterostructure grown epitaxially on AlN, the extent of metal diffusion and the nitrogen vacancy density are limited, particularly for AlGaN layers with a high Al content, which are used in UWBG AlGaN HEMTs. As a result, low resistive ohmic contacts do not form at the source and drain contacts, even in embodiments of the UWBG AlGaN HEMTs that use a heavily doped, reverse graded AlGaN contact layer.

In AlGaN HEMTs described herein, the strain in the semiconductor heterostructure is partially or fully relaxed. This strain relaxation results in a higher density of dislocation defects and nitrogen vacancies and, therefore, a higher degree of metal diffusion into the underlying AlGaN layer (FIG. 2C) without significantly degrading the crystal structure and the surface morphology of AlGaN. As a result, ohmic or near-ohmic source and drain contacts are formed without sacrificing HEMT performance. Using this strain relaxation-based design principle, UWBG AlGaN channel HEMTs with very low contact resistance (e.g., R_{C}<2 Ω·mm) can be fabricated. This low contact resistance can be achieved in UWBG AlGaN channel HEMTs with engineered strain relaxation while maintaining a maximum ON current (Iₘₐₓ), ON resistance (R_{ON}), gate leakage, and breakdown voltage that do not differ significantly from those of their fully-strained counterpart UWBG AlGaN channel HEMTs.

The degree of strain relaxation in the HEMT heterostructure should be high enough to produce an ohmic or near-ohmic contact with the source and drain contacts, but not so high that the crystal quality of the semiconductor heterostructure does not support UWBG HEMT operation. The optimal degree of strain relaxation will depend on the details of the AlGaN HEMT heterostructure. Generally, a percentage of strain relaxation for the one or more partially relaxed layers in a partially relaxed HEMT heterostructure in the range from about 5% to about 40%, including from about 10% to about 30% is suitable. The percentage of strain relaxation in a layer of semiconductor can be measured using X-ray diffraction reciprocal space mapping (RSM), as described in the Example. The RSM was performed using Panalytical Emyrean XRD tool at (−1−1 2 4) AlN plane with ½ degree slit at the source side. A detector was used with fully open channels.

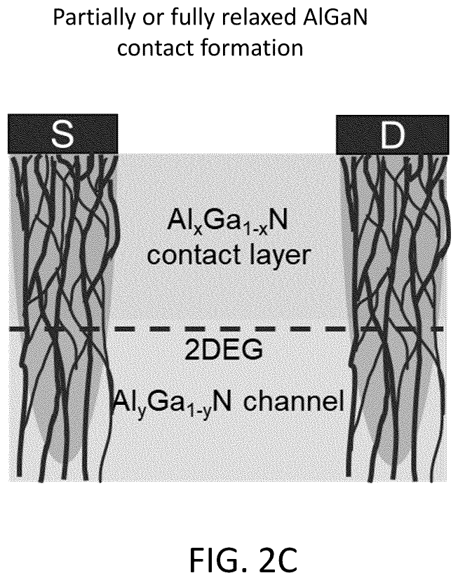

FIG. 3 is a schematic diagram showing the layers in an illustrative UWBG AlGaN channel HEMT with engineered compressive strain relaxation. The HEMTs is based on a heterostructure grown on a substrate, most commonly an aluminum nitride (AlN) substrate, and includes, from the substrate upward, a buffer layer (optional), an AlGaN channel layer, an AlN interlayer, and AlGaN barrier layer, and a reverse graded AlGaN contact layer. The HEMT heterostructure is compressively strained due to the lattice mismatch between the substrate and the semiconductor layers grown thereon. A source contact and drain contact, are deposited on the AlGaN contact layer and a gate contact (G) is deposited on the barrier layer. In the embodiment illustrated in FIG. 3, the HEMT heterostructure is grown using continuous epitaxial growth, wherein the reverse graded AlGaN channel layer is grown flush with the upper surface of the barrier layer.

As indicated in FIG. 3, one or more of the layers making up the heterostructure are at least partially strain-relaxed to facilitate metal diffusion in the heterostructure and a reduction in the contact resistance. The strain relaxation is intentionally engineered into the heterostructure during the epitaxial growth. The degree of strain relaxation can be controlled through the selection of semiconductor alloy composition and/or layer thickness. For example, strain relaxation can be achieved by growing an AlGaN layer on an underlying layer having a different in Al content; generally, the larger the difference in the Al content between the layers, the greater the strain relaxation. Strain relaxation can also be achieved by increasing the layer thickness of a stained layer in the heterostructure, wherein the degree of strain relaxation generally increases with increasing layer thickness. The strain relaxation can be a partial relaxation or a full relaxation of the compressive strain. Other means of achieving full or partial compressive strain relaxation can be achieved by substrate removal, porosification, and other means known in the art.

Strain relaxation engineered into a semiconductor layer in a heterostructure will be imparted to the semiconductor layers subsequently grown thereon while the underlying semiconductor layers in the HEMT heterostructure remain strained to the substrate. Using continuous (“one shot”) epitaxial growth, compressive strain relaxation can be introduced into the buffer layer and all of the layers grown thereon, including the contact layer, into the interlayer and all of the layers grown thereon, including the contact layer, into the barrier layer and the contact layer grown thereon, or only into the contact layer.

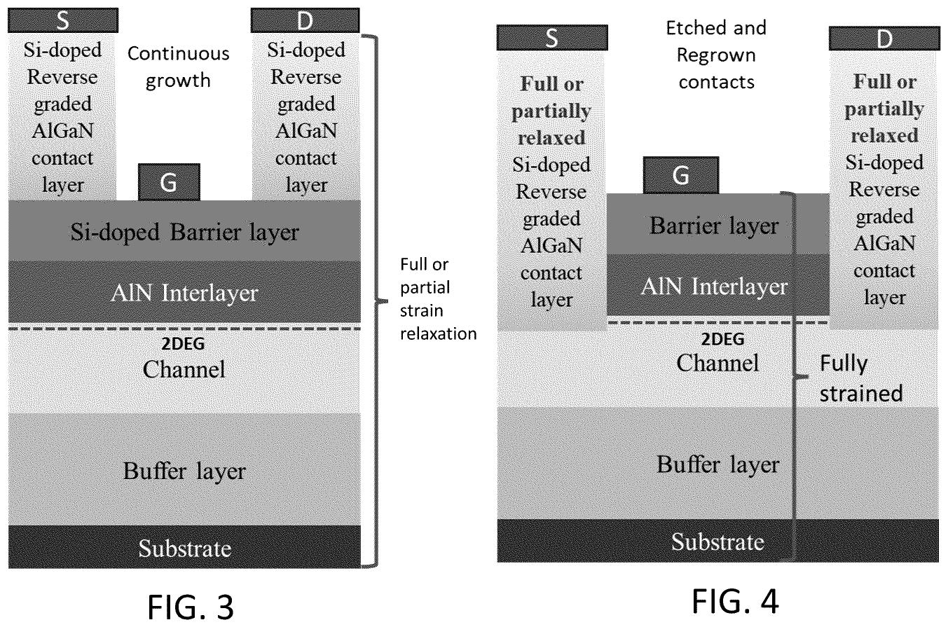

FIGS. 4 through 7 are schematic diagrams of illustrative variations of the UWBG AlGaN channel HEMTs of FIG. 3, each of which has at least partial strain relaxation engineered into one or more layers of the HEMT heterostructure for reduced contact resistance. All of the HEMTs include a substrate, a buffer layer, a channel layer that supports a 2DEG, an AlN interlayer, a barrier layer, and reverse compositionally graded contact layers. Si is used as an illustrative n-type dopant in the figures.

As an alternative to continuous epitaxial growth of the entire heterostructure, a strained heterostructure can be epitaxially grown through the buffer layer followed by a partial etch back into the heterostructure and the subsequent epitaxial growth of the reverse graded AlGaN contact layer on the etched portion of the heterostructure. The regrown reverse graded AlGaN may be grown in a partially or fully relaxed state on the fully strained underlying heterostructure. FIG. 4 is a schematic diagram of a HEMT made using this method. As shown in this example, the buffer layer, channel layer, AlN interlayer, and barrier layer retain the compressive strain imparted by growth on the lattice mismatched substrate, while the etched and regrown n⁺⁺ reverse graded contact layer is recessed into the heterostructure and makes edge contact with the 2DEG and is fully or partially strain relaxed.

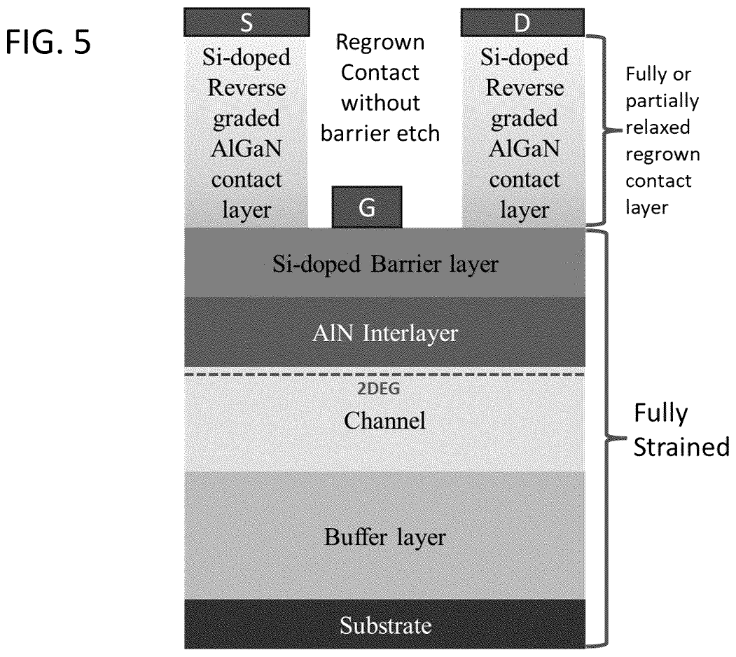

In the HEMT of FIG. 5 the buffer layer, channel layer, AlN interlayer, and barrier layer are grown using continuous epitaxial growth without an etch back and those layers retain the compressive strain imparted to them by the lattice mismatched substrate. However, the reverse graded AlGaN of the contact layer is regrown on AlGaN barrier layer to produce a fully or partially strain-relaxed contact layer on a strained underlying heterostructure.

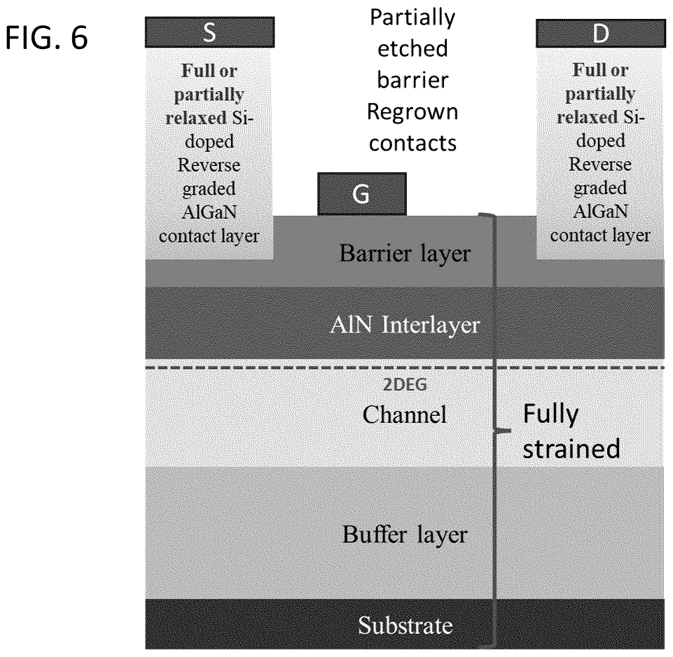

The HEMT of FIG. 6 is another example of a HEMT that is made by continuous growth of the heterostructure through the barrier layer, followed by an etch back into the heterostructure and subsequent growth of a reverse graded AlGaN contact layer on the etched portion of the underlying heterostructure. In this HEMT, the buffer layer, channel layer, AlN interlayer, and barrier layer retain the compressive strain imparted by growth on the lattice mismatched substrate, while the partially etched and regrown n⁺⁺ reverse graded contact layer is fully or partially strain relaxed. This HEMT is similar to that HEMT of FIG. 4, but the etch and regrowth are limited to the barrier layer.

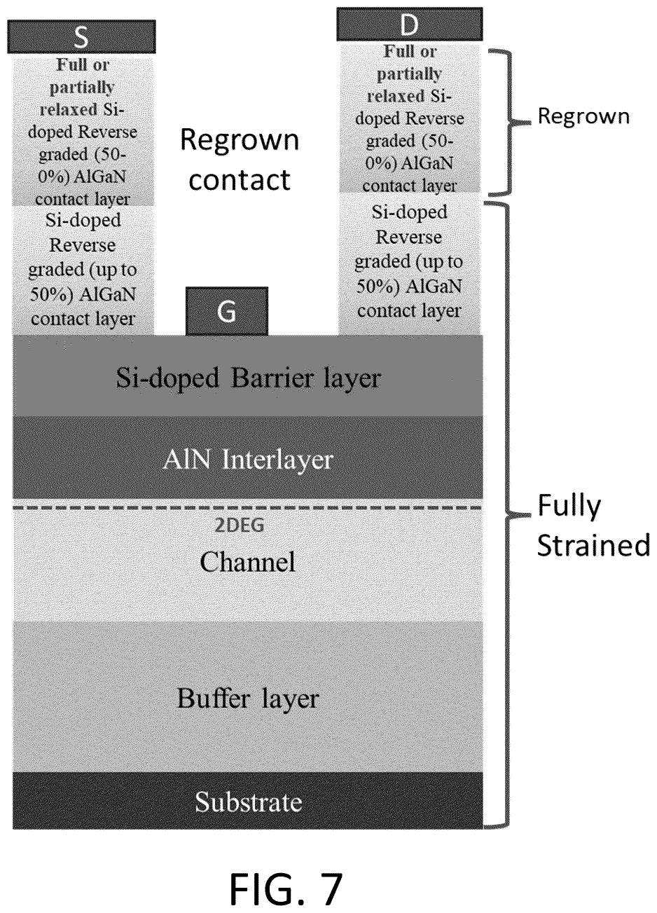

The HEMT of FIG. 7 is made using a various of the method used to form the HEMT of FIG. 5, wherein the buffer layer, channel layer, AlN interlayer, and barrier layer are grown using continuous epitaxial growth without an etch back and those layers retain the compressive strain imparted to them by the lattice mismatched substrate. The reverse graded AlGaN of the contact layer is then grown with grading up to a certain Al composition, followed a regrowth to form a contact layer in which an upper portion of the reverse graded AlGaN is regrown in a fully or partially strain relaxed state, while a lower portion of the reverse graded AlGaN remains compressively strained.

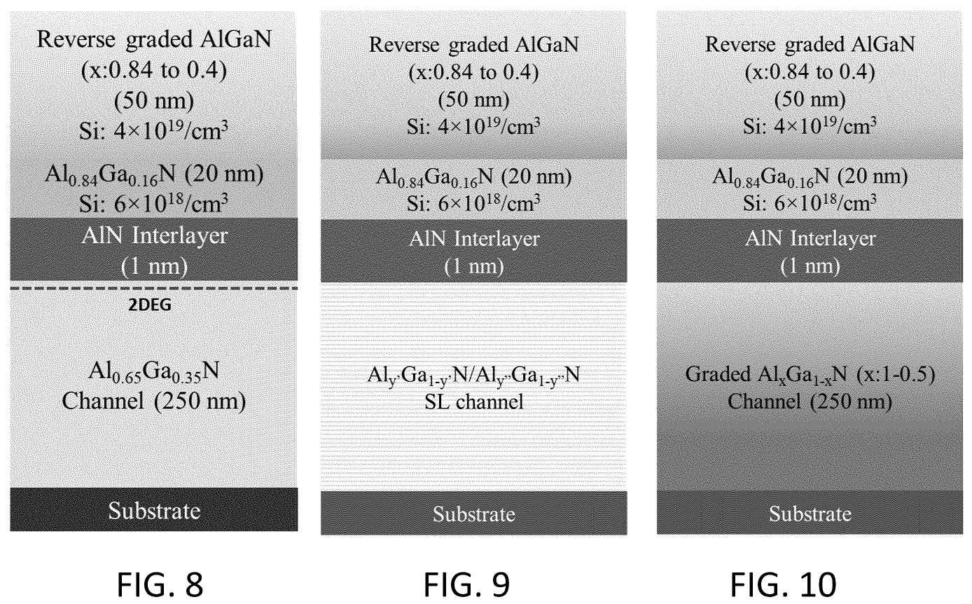

FIGS. 8 through 12 show other variations of the UWBG AlGaN channel HEMTs with fully or partially strain-relaxed heterostructure layers, including variations that can be applied, along or in combination, to the UWBG AlGaN channel HEMTs depicted in FIGS. 3 through 7. The layer thicknesses, AlGaN compositions, Si dopants, and dopant concentrations in these figures are for illustrative purposes only. Other thicknesses, AlGaN compositions, n-type dopants, and dopant concentrations can be used.

FIG. 8 shows a heterostructure that omits a buffer layer, such that the channel layer is grown directly on the substrate. A highly strained HEMT heterostructure can be grown by omitting a buffer layer between an AlN substrate and an Al-rich AlGaN channel layer. If the channel layer is sufficiently thick, the channel layer will partially or fully relax, forming dislocation defects in the channel layer and the overlying layers of the heterostructure.

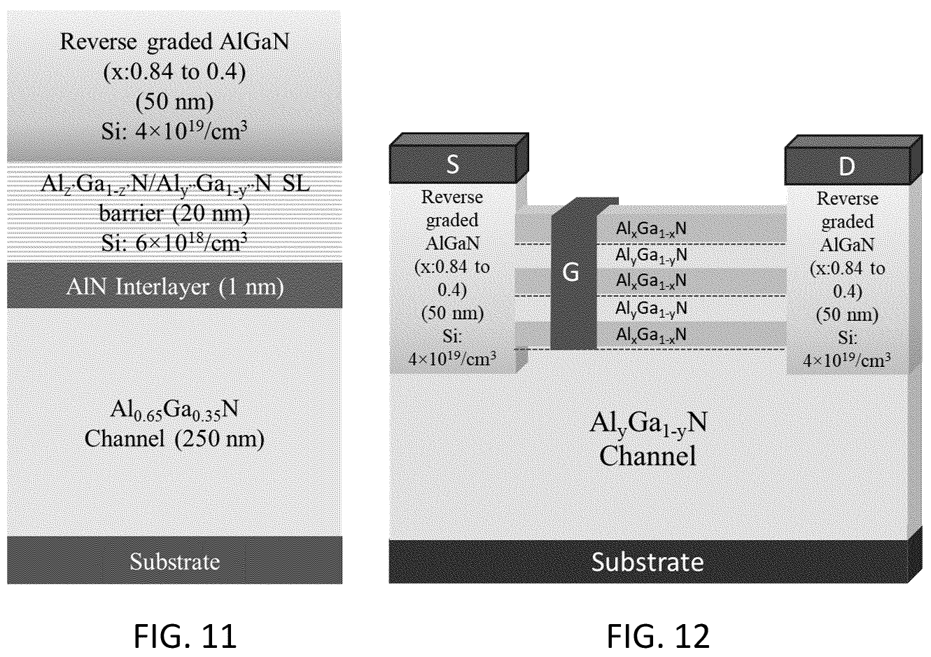

FIG. 9 shows a heterostructure that omits a buffer layer and includes a channel layer having a superlattice (SL) structure. The superlattice is composed of thin (e.g., 0.2 to 20 nm-thick) alternating sublayers of a higher-Al-concentration AlGaN and a lower-Al-concentration AlGaN. The sublayers in a channel superlattice can be represented by alternating sublayers of Al_{y′}Ga_{1-y″}N and Al_{y″}Ga_{1-y″}N, where 1>y′>0, 1>y″>0, and y′≠y″. In some embodiments, the channel having a superlattice structure is used with a buffer layer.

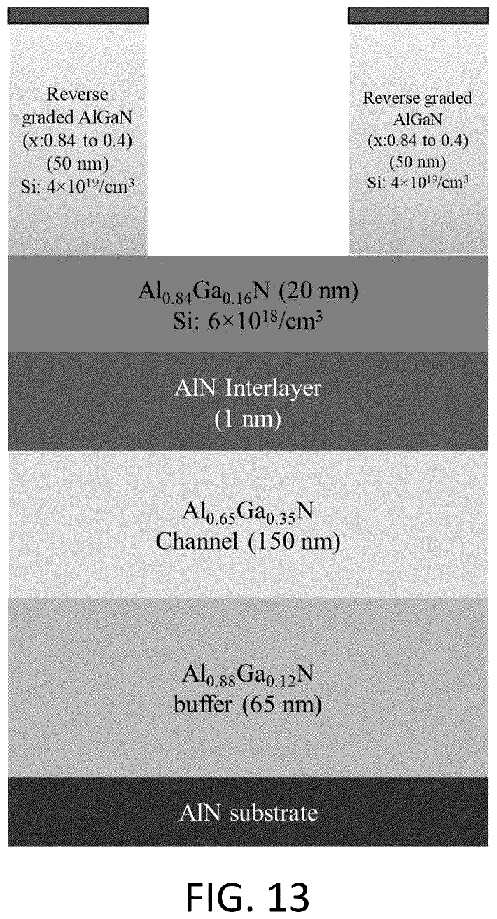

FIG. 10 shows a heterostructure that omits a buffer layer and includes a graded channel layer in which the Al content of the AlGaN alloy reduces through the thickness of the layer from the substrate to the interlayer. In some embodiments, a graded channel layer is used with a buffer layer.

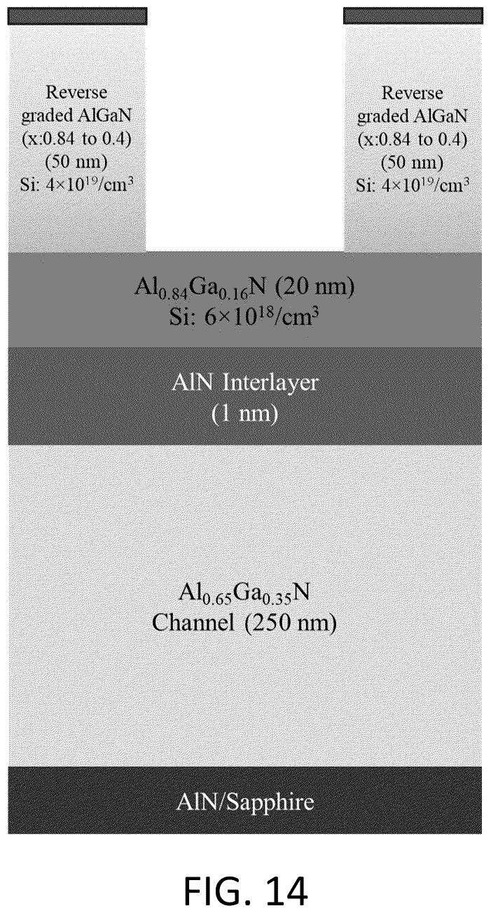

FIG. 11 shows a heterostructure that omits a buffer layer and includes a barrier layer having a superlattice (SL) structure. The superlattice is composed of thin (e.g., 0.2 to 20 nm-thick) alternating sublayers of a higher-Al-concentration AlGaN and a lower-Al-concentration AlGaN. The sublayers in a barrier superlattice can be represented by alternating sublayers of Al_{z′}Ga_{1-z′}N and Al_{z″}Ga_{1-z″}N, where z′>0.5 and z″>0.5, and z′≠z″. In some embodiments, the barrier layer having a superlattice structure is used with a buffer layer.

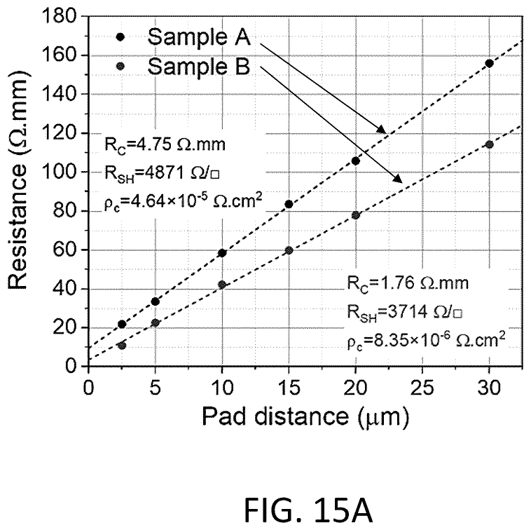

FIG. 12 shows a multichannel HEMT heterostructure that omits a buffer layer, such that the channel layer is grown directly on the substrate. In this variation, the heterostructure comprises a vertical stack of additional channel layers alternating with additional barrier layers on the channel layer, the additional channel layers comprising Al_{y}Ga_{1-y}N where y>0.5, and the additional barrier layers comprising Al_{z}Ga_{1-z}N where z>0.5. In these HEMTs, an additional two-dimensional electron gas is confined in each of the additional channel layers. In some embodiments, the multichannel HEMT structure includes a buffer layer.

### Semiconductor Layers and Materials in an UWBG AlGaN Channel HEMT:

The substrate on which the HEMT heterostructure is grown is one that enables the epitaxial growth of a heterostructure having a crystal quality and surface morphology (e.g., low root mean square, RMS roughness) for a UWBG AlGaN channel HEMT device. A bulk AlN substrate or a substrate that includes a layer of AlN on an underlying support, such as a silicon (Si), silicon carbide (SiC), or sapphire support, are examples of substrates that can be used.

The various Group III-nitride layers making up the HEMT heterostructure can be grown on the substrate using vapor deposition methods, such as metal-organic chemical vapor deposition (MOCVD), including close-coupled showerhead (CCS) MOCVD, plasma chemical vapor deposition, molecular beam epitaxy (MBE), physical vapor transport (PVT), sputtering and hydride vapor phase epitaxy (HVPE). The metal contacts can be deposited by metal deposition techniques, such as atomic layer deposition (ALD), sputtering, or evaporation.

Epitaxial growth using vapor deposition is carried out by exposing the substrate or the growing heterostructure to metal-containing and nitrogen-containing precursor molecules that decompose and react to form the various layers of the HEMT. These precursors may be introduced into the vacuum chamber with a carrier gas, such as hydrogen or nitrogen. For MOCVD growth, the precursors are metal organic compounds, such as trimethyl gallium (TMGa), triethyl gallium (TEGa), trimethyl aluminum (TMAl), triethyl aluminum (TEAl), trimethyl indium (TMI), and triethethyl indium (TEI). Ammonia (NH₃) is typically used as a nitrogen precursor molecule. For the growth of doped semiconductors, a dopant-containing precursor (e.g., silane or disilane, germane for Si doping) is also introduced into the chamber.

The HEMT heterostructure may include an AlGaN buffer layer to facilitate the growth of high-quality crystalline overlayers epitaxially on a lattice mismatched substrate. However, in some embodiments of the HEMTs, the buffer layer is omitted to increase the relaxation in the heterostructure. The composition, grading, and thickness of the buffer layer will depend on the substrate upon which the HEMT heterostructure is grown and the desired degree of relaxation in the layer. Generally, the buffer layer will have an Al content (Al mole fraction) between that of the AlN substrate and the AlGaN alloy of the channel layer. The AlGaN of the buffer layer may be graded (i.e., compositionally graded), such that the Al content in the buffer layer decreases through the thickness of the layer from the substrate to the channel layer. The AlGaN of the buffer layer can be represented by Al_{w}Ga_{1-w}N where w>0.35, w>0.5, and more commonly w>0.8. A graded buffer layer may be graded from a maximum Al content, w=1, at the interface with the substrate down to the Al content of an overlying channel layer at the interface with said channel layer. The buffer layer may be undoped (“unintentionally doped”) or n-type doped. (For the purposes of this disclosure, a semiconductor material that has not been extrinsically doped is referred to as undoped or unintentionally doped.) By way of illustration only, the buffer layer can have an n-type dopant concentration in the range from 5×10¹⁵ to 5×10¹⁹ cm⁻³. Silicon dopants are a non-limiting example of n-type dopants for AlGaN alloys. However, other n-type dopants, such as germanium, can be used. The buffer layer thickness is typically in the range from about 50 nm to 500 nm, including the range from 50 nm to 200 nm. However, thicknesses outside of these ranges can be used.

The channel layer in a AlGaN channel HEMT heterostructure may be grown on the buffer layer or, in the absence of a buffer layer, on the substrate. The AlGaN of the channel layer can be represented by Al_{y}Ga_{1-y}N where y>0.35, including >0.5, and further including y>0.6. The Al_{y}Ga_{1-y}N of the channel layer may be graded, such that the Al content in the channel layer reduces through the thickness of the layer from the interface with a buffer layer to the interface with an overlying AlN interlayer layer. In some embodiments of the HEMT heterostructure that include a graded channel layer, the AlGaN of the channel layer is graded such that the Al content decreases from the interface with a buffer layer to the interface with an overlying AlN interlayer. In some embodiments, the channel layer has a superlattice structure of alternating Al_{y′}Ga_{1-y′}N and Al_{y″}Ga_{1-y″}N alloy sublayers. The channel layer may be undoped (“unintentionally doped”) or n-type doped. By way of illustration only, the channel layer can have an n-type dopant concentration in the range from 5×10¹⁵ to 5×10¹⁹ cm⁻³. Silicon dopants are a non-limiting example of n-type dopants for AlGaN alloys. However, other n-type dopants, such as germanium, can be used. The channel layer thickness is typically in the range from about 50 nm to 500 nm. However, thicknesses outside of these ranges can be used. The channel layer in a HEMT that does not include a buffer layer will typically be thicker than a HEMT that has a buffer layer. By way of illustration only, an AlGaN HEMT that does not include a buffer layer may have a channel layer thickness in the range from 50 nm to 2000 nm, including in the range from 200 nm to 300 nm.

An AlN interlayer between the AlGaN channel layer and the AlGaN barrier layer improves the mobility of the two-dimensional electron gas (2DEG). The intervening AlN layer can be very thin, having, for example, a thickness of less than 5 nm or even less than 2 nm. By way of illustration only, AlN layers having thicknesses in the range from 0.5 to 2.0 nm, including in the range from 1.0 to 1.5 nm, are generally suitable.

The barrier layer of the HEMT heterostructure is grown on the interlayer. The Group III-nitride of the barrier layer can be represented by Al_{z}M_{1-z}N where z>0.5, including z>0.8, and M represents gallium (Ga), scandium (Sc), yttrium (Y), boron (B), or indium (In). The Al content (z) of the Al_{z}M_{1-z}N is higher than the Al content (y) of the channel layer to provide the conduction band offset necessary to create a potential well for electron confinement in the 2DEG. A difference in Al content between the channel layer and the barrier layer of about 15% to about 20% is generally sufficient. The barrier layer may be undoped (“unintentionally doped”) or n-type doped. By way of illustration only, the barrier layer can have an n-type dopant concentration in the range from 5×10¹⁵ to 5×10¹⁹ cm⁻³. Silicon dopants are a non-limiting example of n-type dopants for AlMN alloys. However, other n-type dopants, such as germanium, can be used. Silicon is typically used as the n-type dopant for n-AlGaN. In some embodiments, the barrier layer has a superlattice structure of alternating Al_{z′}M_{1-z′}N and Al_{z″}M_{1-z″}N alloy sublayers. Superlattice barrier layers can be used to improve the 2DEG electron mobility and carrier density of the UWBG AlGaN channel HEMTs. The barrier layer is typically much thinner than the channel layer and thicker than the AlN interlayer. Typical barrier layer thicknesses are in the range from about 2 nm to 100 nm, including in the range from 10 nm to 50 nm. However, thicknesses outside of these ranges can be used.

A reverse graded AlGaN alloy provides a contact layer between the metal source and drain contacts and the underlying semiconductor layers of the HEMT heterostructure. The contact layer can be grown directly on the barrier layer or can be recessed into the underlying heterostructure layers by an etch and epitaxial regrowth process, as described above. The AlGaN of the contact layer, which can be represented by AlₓGa₁₋ₓN, is graded such that the Al mole fraction is high at the interface between the contact layer and an underlying HEMT heterostructure layer and decreases moving away from that interface in the direction of the source and drain contacts. In some embodiments of the AlGaN channel HEMTs, the Al content, x, of the reverse graded AlₓGa₁₋ₓN and the Al content, z, of the Al_{z}M_{1-z}N are equal (i.e., x=z) at an interface between the contact layer and the barrier layer. In some embodiments of the AlGaN HEMTs, the Al content, x, of the reverse graded AlₓGa₁₋ₓN and the Al content, y, of the Al_{y}Ga_{1-y}N are equal (i.e., x=y±0.1) at an interface between the contact layer and the channel layer. The AlₓGa₁₋ₓN may be reversed graded to an Al content, x, of 0.5 or less, or 0.4 or less, including x=0, at the interface between the contact layer and the source and drain contacts.

The AlₓGa₁₋ₓN of the contact layer is heavily n-type doped with a dopant concentration of at least 1×10¹⁸ cm⁻³. By way of illustration, the AlₓGa₁₋ₓN may have an n-type dopant concentration in the range from 1×10¹⁸ to 5×10²¹ cm⁻³. Silicon dopants are a non-limiting example of n-type dopants for AlGaN alloys. However, other n-type dopants, such as germanium, can be used. The contact layer thickness is typically in the range from about 20 nm to 200 nm. However, thicknesses outside of these ranges can be used.

Various metals and metal alloys can be used to form the source and drain contacts and the gate contact. By way of illustration only, the source and drain contacts can be composed of titanium, aluminum, nickel, gold, molybdenum, vanadium, zirconium, or alloys thereof, and the gate contact may be composed of titanium, platinum, chromium, nickel, or alloys of titanium and tungsten. The contacts may be single-layer or multilayered contacts comprising two or more layers of metal. The metal contacts can be deposited by a variety of methods, such as e-beam evaporation or sputtering followed by a thermal anneal to promote the diffusion of metal into the underlying HEMT heterostructure. Typical thermal anneal temperatures include those in the range from 600° C.-1100° C. and typical thermal anneal times include those in the range from 700° C.-1000° C.

### Example

Ultra-wide bandgap (UWBG) Al_{0.65}Ga_{0.35}N channel HEMTs were deposited using a close-coupled showerhead (CCS) metal-organic chemical vapor deposition (MOCVD) reactor on AlN-on-sapphire templates. The fabricated HEMT device showed state-of-the-art contact resistivity (ρ_{c}=8.35×10⁻⁶ Ω·cm²), low leakage current (<10⁻⁶ A/mm), high I_{ON}/I_{OFF} ratio (>10⁵), a breakdown voltage of 2.55 kV and a Baliga's figure of merit (BFOM) of 260 MW/cm².

A HEMT device with partial strain relaxation was fabricated on an AlGaN channel epitaxial layer featuring a 250 nm channel thickness, without incorporating a high-composition buffer layer. The device showed state-of-the-art contact resistance (1.76 Ω·mm) and breakdown voltage (2.55 kV) along with a BFOM of 260 MW/cm². The specific contact resistance, breakdown voltage, and specific on-resistance were compared with the state-of-the-art devices reported in the literature.

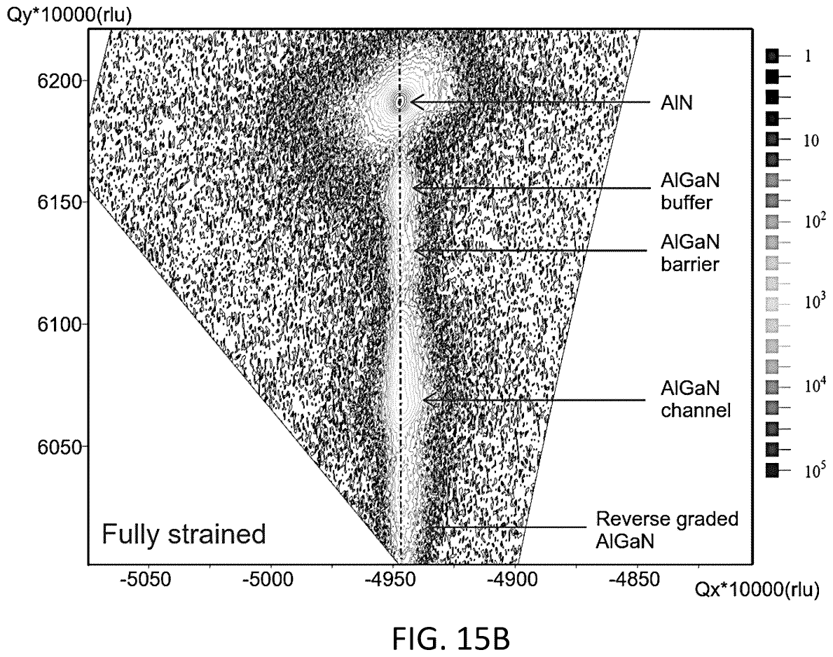

This Example demonstrates MOCVD deposition of UWBG AlGaN channel HEMTs using a 3×2″ Aixtron CCS MOCVD reactor. In a comparative, fully strained HEMT device, the Al composition of the buffer layer, the thickness of the channel, and the AlN interlayer were optimized for obtaining higher charge (~10¹³/cm²) and mobility (>150 cm²/V·s) in the 2DEG (FIG. 13). The HEMT structure consists of a high-composition (x_{Al}:0.88) AlxGai-xN buffer layer (65 nm) followed by an Al_{0.65}Ga_{0.35}N channel (150 nm) layer, 1 nm AlN interlayer, and a 20 nm Si-doped (6×10¹⁸/cm³) Al_{0.84}Ga_{0.16}N barrier layer and a Si-doped (4×10¹⁹/cm³) reverse-graded (x_{Al}:0.84 to 0.4) AlGaN layer. The epitaxial structures were deposited at 1210° C. with trimethylaluminum (TMAl), triethylgallium (TEGa), and ammonia (NH₃) precursors on AlN on sapphire templates with dislocation densities ~4.5×108 cm⁻². H₂ was used as a carrier gas and silane was used as a gaseous precursor for Si doping in the AlGaN layers.

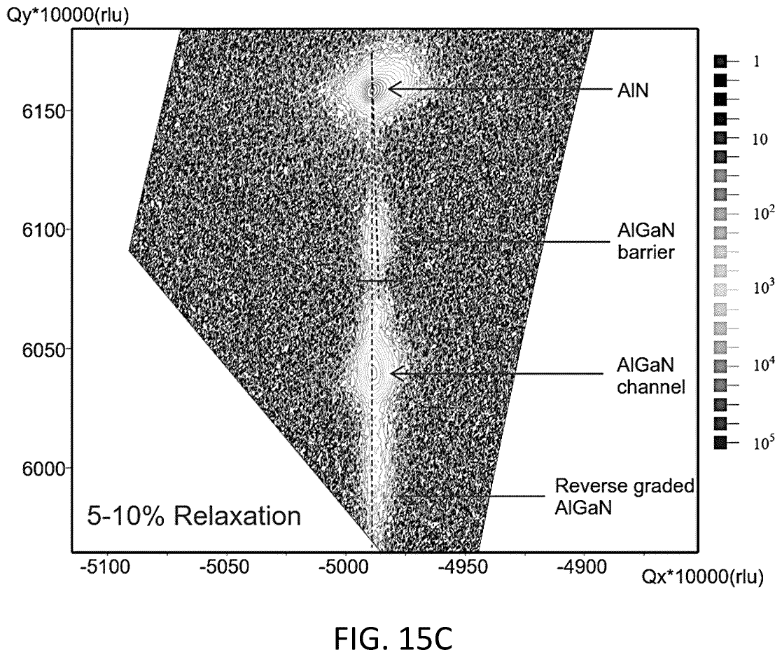

A HEMT structure without a buffer layer with a 250 nm-thick channel, a 1 nm-thick AlN interlayer, a 20 nm Si-doped (6×10¹⁸/cm³) Al_{0.84}Ga_{0.16}N barrier layer and a Si-doped (4×10¹⁹/cm³) reverse-graded (x_{Al}:0.84 to 0.4) AlGaN layer was deposited (FIG. 14). A 250 nm channel thickness was selected to ensure excellent crystalline quality and optimized 2DEG transport properties. The device fabrication consisted of ohmic contact pad deposition for source and drain using Ti/Al/Ni/Au by e-beam evaporation followed by rapid thermal annealing (RTA) at 900° C. in N₂ ambient for 30 s. Then the reverse-graded AlGaN layer was removed from the access region followed by mesa isolation of the devices using Cl₂-based inductive coupled plasma reactive ion etching (ICP-RIE). Ni/Au was deposited using e-beam evaporation for gate metal deposition. Finally, HEMT devices were fabricated on the epitaxial structures with gate length L_{G}=2 μm, source-to-gate length L_{SG}=1.5 μm and source-to-drain length L_{SD}=23 μm.

Atomic force microscopy (AFM) measurements were performed to determine the crystalline quality and surface roughness of the AlGaN channel HEMTs. DC measurements of the HEMTs were performed using Keysight B1505A SMU (source-measurement unit) to understand the effect of buffer and channel design on device performance.

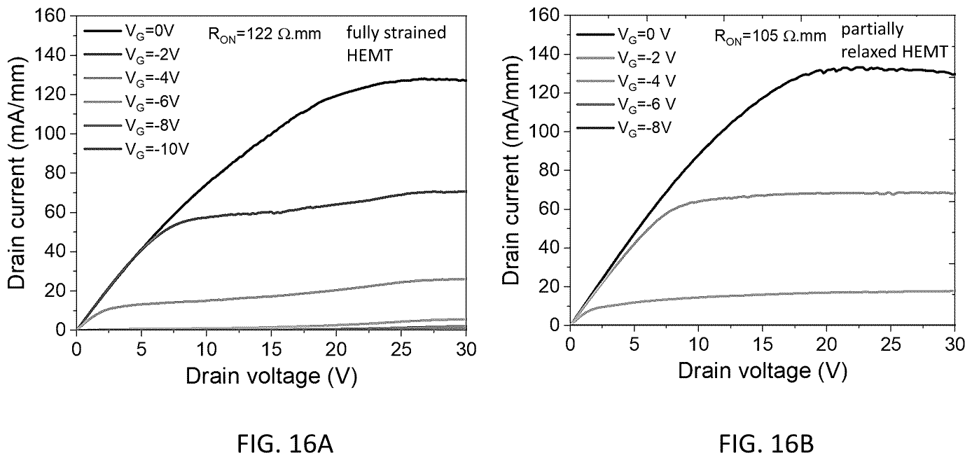

DC measurements were performed on the fully strained (Sample A) and partially relaxed (Sample B) devices. The sheet resistance (R_{SH}) and contact resistance (R_{C}) were measured using transmission line measurement (TLM) (FIG. 15A). The measured R_{SH} and R_{C} for Sample A and Sample B were 4871 Ω/□, 3714Ω/□ and 4.75 Ω·mm, 1.76 Ω·mm, respectively. The contact resistivities (ρ_{c}) for Sample A and Sample B were 4.64×10⁻¹ Ω·cm² and 1.67×10⁻⁵ Ω·cm², respectively. This was the lowest R_{C} (1.76 Ω·mm) and ρ_{c} (1.67×10⁻⁵ Ω·cm²) achieved in an extreme bandgap AlGaN channel HEMT using standard Ti/Al/Ni/Au contacts. (A. Mamun, et al., Appl. Phys. Express 16(6), 061001 (2023); K. Hussain et al., Appl. Phys. Express 16(1), 014005 (2023).) The partially relaxed device showed much lower contact resistance compared to the fully strained device due to the relaxation (5-10%) in the barrier layer (measured using RSM at (−1 −1 2 4) AlN plane), which was introduced by the removal of the high-composition AlGaN buffer layer and increasing channel thickness from 150 nm to 250 nm (FIGS. 15B and 15C). The dislocation density generated by 5-10% relaxation was found to be sufficient to decrease the contact resistance by 63%. The channel thickness was kept at 250 nm to minimize the degradation of the crystalline quality while still getting the advantage of slight relaxation (5-10%) for improved ohmic contact formation.

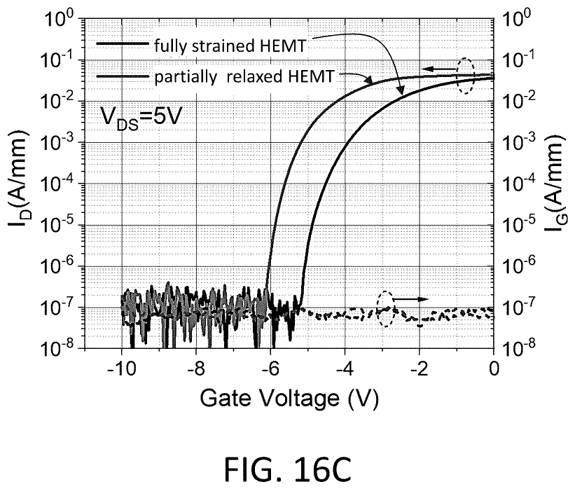

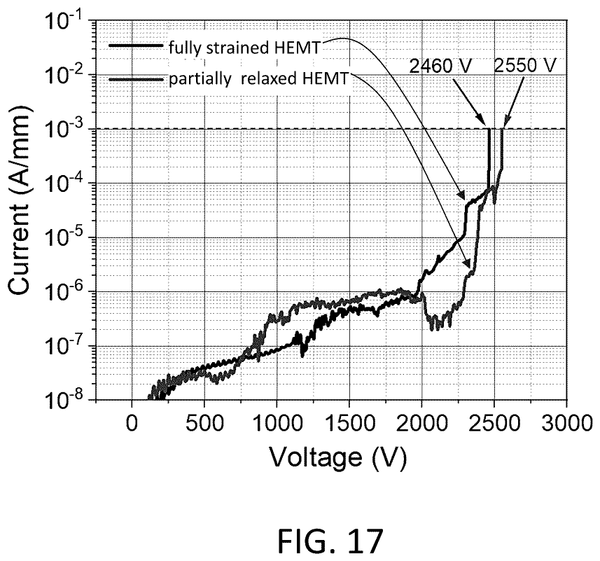

However, the slight relaxation of the barrier layer did not affect the DC and breakdown performance of the partially relaxed HEMT device compared to the fully strained HEMT device. The I_{D}−V_{D} characteristics are shown in FIGS. 16A-16B showing a maximum ON current (Iₘₐₓ) of 128 mA/mm and 133 mA/mm for the fully strained HEMT and partially relaxed HEMT, respectively. The measured ON resistances (R_{ON}) of the devices were 122 Ω·mm and 105 Ω·mm for the fully strained HEMT and partially relaxed HEMT, respectively. The gate leakage was significantly low at 10⁻⁷ A/mm, and the I_{ON}/I_{OFF} ratio exceeded 10⁵ for both devices (FIG. 16C). The breakdown voltage (BV) of the HEMTs was >2 kV, where the fully strained HEMT showed a BV of 2460 V and the partially relaxed HEMT demonstrated a breakdown voltage of 2550 V (FIG. 17). The BVs were similar for both devices, indicating that the design of the thicker channel layer without a high-composition AlGaN buffer layer did not affect the breakdown voltage.

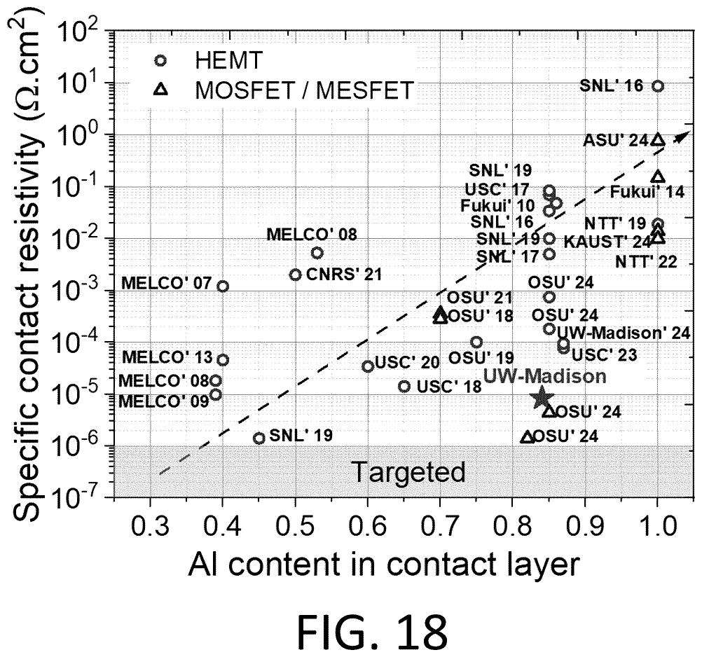

FIG. 18 compares specific contact resistance for various Al-compositions in the high-composition AlGaN contact layer with state-of-the-art data from the literature with this Example (marked with a star and UW-Madison).

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. An AlGaN channel high electron mobility transistor comprising:
a strained heterostructure on a substrate, the strained heterostructure comprising:
a channel layer comprising Al_{y}Ga_{1-y}N where y>0.35;
a two-dimensional electron gas confined in the channel layer;
an AlN interlayer on the channel layer;
a barrier layer on the AlN interlayer, the barrier layer comprising Al_{z}M_{1-z}N, wherein M represents Ga, Sc, Y, B, or In and z>0.5; and
a contact layer on the barrier layer or etched and regrown into or through the barrier layer, the contact layer comprising reverse graded n-type doped AlₓGa₁₋ₓN, where 1≤x≤0, the reverse graded n-type doped AlₓGa₁₋ₓN having an n-type dopant concentration in a range from 1×10¹⁸ cm⁻³ to 5×10²⁰ cm⁻³;
a source contact on the contact layer;
a drain contact on the contact layer; and
a gate contact on the barrier layer,
wherein the contact layer is at least partially strain-relaxed.

2. The AlGaN channel high electron mobility transistor of claim 1, wherein at least one of the AlN interlayer, the barrier layer, and the channel layer is at least partially strain-relaxed.

3. The AlGaN channel high electron mobility transistor of claim 1, wherein the contact layer has a percentage of strain relaxation in the range from 5% to 100%.

4. The AlGaN channel high electron mobility transistor of claim 2, wherein the at least one of the AlN interlayer, the barrier layer, and the channel layer that is at least partially strain relaxed has a percentage of strain relaxation in the range from 5% to 100%.

5. The AlGaN channel high electron mobility transistor of claim 1, wherein the substrate is a bulk AlN substrate or a layer of AlN on an underlying support.

6. The AlGaN channel high electron mobility transistor of claim 5, wherein the channel layer is directly on the substrate.

7. The AlGaN channel high electron mobility transistor of claim 6, wherein the channel layer has a thickness in the range from 50 nm to 2000 nm.

8. The AlGaN channel high electron mobility transistor of claim 5, further comprising a buffer layer between the substrate and the channel layer, the buffer layer comprising Al_{w}Ga_{1-w}N where w>0.35 or comprising graded Al_{w}Ga_{1-w}N where w varies in the range from 1≤w≤y.

9. The AlGaN channel high electron mobility transistor of claim 1, wherein the barrier layer is partially etched under the source contact and the drain contact and the contact layer is regrown on the partially etched barrier layer resulting in the contact layer being at least partially strain-relaxed.

10. The AlGaN channel high electron mobility transistor of claim 9, wherein the contact layer is fully strain-relaxed.

11. The AlGaN channel high electron mobility transistor of claim 1, wherein the barrier layer, AlN interlayer, and channel layer are etched under the source contact and the drain contact and the contact layer is regrown resulting in the contact layer being at least partially strain-relaxed.

12. The AlGaN channel high electron mobility transistor of claim 11, wherein the reverse graded n-type doped AlₓGa₁₋ₓN of the contact layer has x<0.4 at an interface with the channel layer and a x<0.4 at the source contact and the drain contact.

13. The AlGaN channel high electron mobility transistor of claim 1, wherein a portion of the contact layer adjacent to the source contact and/or the drain contact is at least partially strain-relaxed and an underlying portion of the contact layer is fully strained.

14. The AlGaN channel high electron mobility transistor of claim 1, wherein the channel layer has a superlattice structure, wherein the Al_{y}Ga_{1-y}N comprises alternating sublayers of Al_{y′}Ga_{1-y′}N and Al_{y″}Ga_{1-y″}N, where 1>y′>0, 1>y″>0, and y′≠y″.

15. The AlGaN channel high electron mobility transistor of claim 1, wherein the Al_{y}Ga_{1-y}N of the channel layer is graded having an Al content that is lowest at an interface with the interlayer and increased in a direction away from the interface with the interlayer.

16. The AlGaN channel high electron mobility transistor of claim 1, wherein the barrier layer has a superlattice structure, wherein the Al_{z}Ga_{1-z}N comprises alternating sublayers of Al_{z′}M_{1-z′}N and Al_{z″}M_{1-z″}N, where z′>0.5 and z″>0.5, and z′≠z″.

17. The AlGaN channel high electron mobility transistor of claim 1, wherein one or both of the Al_{z}M_{1-z}N of the barrier layer and the Al_{y}M_{1-y}N of the channel layer is doped with n-type dopant and has an n-type dopant concentration in the range from 5×10¹⁵ to 5×10¹⁹ cm⁻³.

18. The AlGaN channel high electron mobility transistor of claim 8, wherein the Al_{w}Ga_{1-w}N of the buffer layer is doped with n-type dopant and has an n-type dopant concentration in the range from 5×10¹⁵ to 5×10¹⁹ cm⁻³.

19. The AlGaN channel high electron mobility transistor of claim 1, wherein the heterostructure comprises a vertical stack of additional channel layers alternating with additional barrier layers on the channel layer, the additional channel layers comprising Al_{y}Ga_{1-y}N where y>0.35, and the additional barrier layers comprising Al_{z}M_{1-z}N where z>0.5, wherein an additional two-dimensional electron gas confined in each of the additional channel layers.

20. The AlGaN channel high electron mobility transistor of claim 2, wherein the substrate is a bulk AlN substrate or a layer of AlN on an underlying support, Al_{z}M_{1-z}N is Al_{z}Ga_{1-z}N, and the channel layer is directly on the substrate.
